(19) United States
(12) Patent Application Publication
(10) Pub. No.: US 2013/0084758 A1
(43) Pub. Date: Apr. 4, 2013

(54) CONTACT AND ELECTRICAL CONNECTOR

(71) Applicant: J.S.T. MFG. CO., LTD., Osaka (JP)

(72) Inventors: Hirotaka MIZUTA, Miyoshi-shi (JP); Muneo FUKUNAGA, Miyoshi-shi (JP)

(73) Assignee: J.S.T. MFG. CO., LTD., Osaka (JP)

(21) Appl. No.: 13/644,023

(22) Filed: Oct. 3, 2012

(30) Foreign Application Priority Data
Oct. 4, 2011 (JP) 2011-220021

(51) Int. Cl. H01R 13/03; H01R 13/40

(52) U.S. Cl. 439/733.1; 439/886

(57) ABSTRACT

A contact includes a contact portion to which a conductive portion of a connecting member is connected upon sliding in at least one sliding direction. The contact includes a first arm portion extending in parallel to the sliding direction. The arm portion includes a punched surface, a chevron portion provided on the punched surface and projecting in a direction intersecting the sliding direction, and a gold plating layer provided on the punched surface. The chevron portion has an apex portion making up the contact portion and one pair of inclined surface portions disposed at respective sides of the apex portion in regard to the sliding direction. The gold plating layer provided on the punched surface is disposed only on at least a portion of the inclined surface portion at an opposite direction side of the sliding direction and at least a portion of the apex portion.

### BACKGROUND OF THE INVENTION

1. Field of the Invention

The present invention relates to a contact and an electrical connector that includes the contact.

2. Description of Related Arts

Plating is usually applied to a surface of a contact used in a connector. For example, nickel plating is applied to impart corrosion resistance and suppress solder wicking, and gold plating is applied to reduce electrical resistance.

For example, in surface processing of a contact, when a gold plating is to be applied partially after performing nickel plating, a method where a portion on which the gold plating is not to be applied (portion on which the nickel plating is to be left) is covered with a masking tape or a jig is generally employed.

On the other hand, Patent Document 1 (Japanese Published Unexamined Patent Application No. 2005-347039) proposes a method where an elongate conductive plate, having a plurality of contacts formed integrally in a horizontal row, is conveyed in a longitudinal direction and an insulating ink, insoluble to a plating liquid, is jetted from an inkjet arrangement in a direction oblique to both top and rear surfaces of the conductive plate to form a resin layer having a masking effect on both top and rear surfaces and side surfaces of the contacts.

As shown in FIG. 1 of Patent Document 1, the resin layer formed of the insulating ink is formed in a region extending from central portions to base end portions in a longitudinal direction of one pair of arm portions of each fork-shaped contact. The gold plating is thus applied to an entirety of a region extending from the central portions to tip end portions in the longitudinal direction of the pair of arm portions. The expensive gold plating is thus applied to a region of substantially half of the arm portions, thus making the contact high in manufacturing cost.

To reduce the manufacturing cost, it is preferable to lessen the region on which the gold plating is applied as much as possible. However, in a case where the gold plating is applied to just a contact portion of the contact, there is the following problem.

For example, in a case where a gold-plated conductive portion of a connecting member of an FPC (flexible printed circuit), etc., is slid in parallel along an arm portion of a contact and connected to a contact portion via an inclined surface portion of the arm portion, a nickel plating of the inclined surface portion of the arm portion is shaved off by the conductive portion of the connecting member and becomes nickel shavings that are carried to the contact portion, and the nickel shavings may become interposed between the conductive portion (gold plating) and the contact portion (gold plating). Contact resistance of the contact portion may thus increase. In particular, nickel readily forms an oxide coating and readily increases in contact resistance.

An object of the present invention is to provide a contact and an electrical connector that are low in manufacturing cost and are capable of suppressing increase in contact resistance.

### SUMMARY OF THE INVENTION

To achieve the above object, in one aspect of the present invention, a contact includes an arm portion having a contact portion to which a conductive portion of a connecting member is connected upon sliding in at least one sliding direction. The arm portion includes a punched surface, a chevron portion provided on the punched surface and projecting in a direction intersecting the sliding direction, and a gold plating layer provided on the punched surface. The chevron portion has an apex portion making up the contact portion and at least one pair of inclined surface portions disposed at both sides of the apex portion in regard to the sliding direction. The gold plating layer provided on the punched surface is disposed only on at least a portion of the inclined surface portion at an opposite direction side of the sliding direction and at least a portion of the apex portion.

With the present invention, an amount of gold can be reduced to reduce manufacturing cost because the gold plating layer provided on the punched surface of the arm portion is disposed only on at least a portion of the inclined surface portion at the opposite direction side of the sliding direction and at least a portion of the apex portion. Moreover, shaving off, for example, of nickel or other dissimilar metal can be suppressed until the conductive portion of the connecting member reaches the contact portion of the arm portion of the contact. Consequently, interposition of nickel shavings or other dissimilar metal between the conductive portion and the contact portion can be suppressed and increase in contact resistance can be suppressed.

### BRIEF DESCRIPTION OF THE DRAWINGS

FIG. 1 is a schematic sectional view of an electrical connector that includes a contact according to a preferred embodiment of the present invention.

FIG. 2 is a schematic perspective view of the contact of FIG. 1.

FIG. 3 is an enlarged perspective view of a principal portion of a first arm portion of the contact of FIG. 2.

FIG. 4 is an enlarged perspective view of a principal portion of a second arm portion of the contact of FIG. 2.

FIG. 5 is a schematic sectional view of the first arm portion of the contact of FIG. 2.

FIG. 6 is a schematic sectional view of an electrical connector that includes contacts according to another preferred embodiment of the present invention.

FIG. 7 is a schematic perspective view of a contact of FIG. 6.

FIG. 8 is a schematic sectional view of the contact of FIG. 7.

FIG. 9 is a schematic exploded perspective view of a socket connector as an electrical connector including contacts according to yet another preferred embodiment of the present invention and a base connector.

FIG. 10 is a schematic sectional view of the socket connector of FIG. 9.

FIG. 11 is a schematic perspective view of a contact of the socket connector of FIG. 10 and shows a state before crimping onto an electrical wire.

FIG. 12 is an enlarged perspective view of a first arm portion of the contact of FIG. 11.

FIG. 13 is schematic sectional view of a principal portion of the first arm portion of the contact of FIG. 11.

FIG. 14 is a schematic perspective view of a principal portion of a first arm portion of a contact according to yet another preferred embodiment of the present invention.

FIG. 15A is a schematic perspective view of a principal portion of a first arm portion of a contact according to yet another preferred embodiment of the present invention and FIG. 15B is a schematic view of a contact portion of the contact of FIG. 15A and a connecting member.

### DETAILED DESCRIPTION OF THE PREFERRED EMBODIMENTS

Preferred embodiments of the present invention shall now be described with reference to the attached drawings.

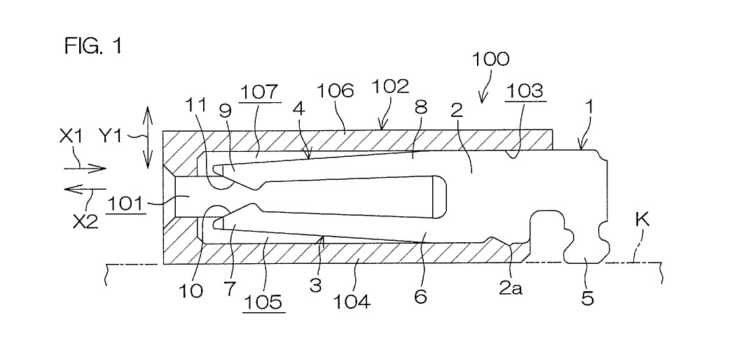

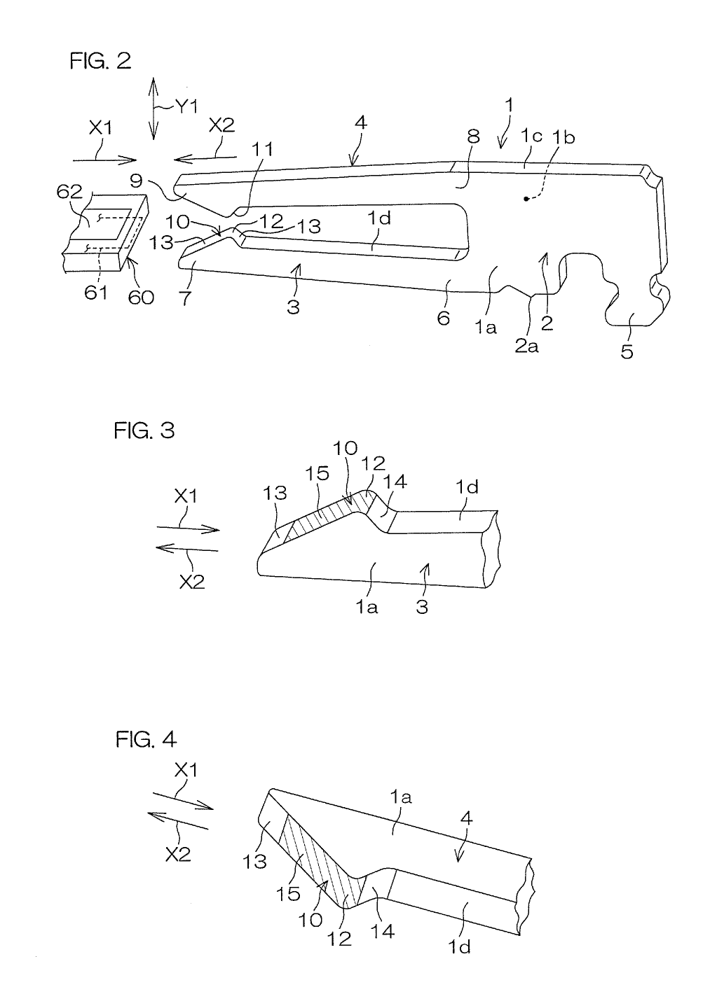

FIG. 1 is a sectional view of an electrical connector that includes a contact according to a preferred embodiment of the present invention, and FIG. 2 is a schematic perspective view of the contact. As shown in FIG. 1, the electrical connector 100 includes a housing 102 made of an insulating synthetic resin and having formed therein an insertion recess 101 for insertion of a connecting member, and the contact 1 made of metal and held by the housing 102. The contact 1 is fixed to a substrate K by soldering, etc.

Referring to FIG. 2, the contact 1 is a so-called punched contact formed through a process of punching a plate material by a press. The contact 1 is a fork-shaped contact connected to a plate-like connecting member 60, which is a member, for example, of an FPC, etc., and is inserted along a predetermined sliding direction X1. The contact 1 has one pair of plate surfaces 1a and 1b and a punched surface 1c intersecting the plate surfaces 1a and 1b and connecting the two plate surfaces 1a and 1b across an entire circumference.

As shown in FIG. 1 and FIG. 2, the contact 1 has a main body portion 2 with a substantially rectangular shape, a first arm portion 3 and a second arm portion 4 extending substantially in parallel in an opposite direction X2 of the sliding direction X1 from one end of the main body portion 2, and a lead portion 5 extending in a direction orthogonal to the sliding direction X1 from another end of the main body portion 2.

The main body portion 2 has a press-fitting projection 2a and is press-fitted into a fixing hole 103 of the housing 102. The first arm portion 3 is housed and held in a first housing groove 105 formed in a first plate portion 104 of the housing 102 and facing the insertion recess 101. The second arm portion 4 is housed and held in a second housing groove 107 formed in a second plate portion 106 of the housing 102 and facing the insertion recess 101.

The first arm portion 3 includes a base end portion 6 coupled to the main body portion 2 and a tip end portion 7 that is a free end, and the second arm portion 4 includes a base end portion 8 coupled to the main body portion 2 and a tip end portion 9 that is a free end.

The first arm portion 3 and the second arm portion 4 respectively have, at the respective tip end portions 7 and 9, a first chevron portion 10 and a second chevron portion 11 projecting mutually inward in a direction Y1 intersecting the sliding direction X1 and penetrating inside the insertion recess 101 as shown in FIG. 1.

The first chevron portion 10 of the first arm portion 3 and the second chevron portion 11 of the second arm portion 4 make up a symmetrical structure. As shown in FIG. 3 and FIG. 4, the first chevron portion 10 and the second chevron portion 11 are respectively formed on portions of the punched surface 1c, that is, on punched surfaces 1d of the first arm portion 3 and the second arm portion 4. The first chevron portion 10 includes an apex portion that makes up a contact portion 12 and one pair of inclined surface portions 13 and 14 disposed at respective sides of the apex portion (contact portion 12). The inclined surface portion 13 is disposed at the opposite direction X2 side of the sliding direction X1 with respect to the contact portion 12 and the inclined surface portion 14 is disposed at the sliding direction X1 side with respect to the contact portion 12.

Gold plating layers 15 (corresponding to hatched portions in FIG. 3 and FIG. 4) are coated on the punched surfaces 1d of the first arm portion 3 and the second arm portion 4. The gold plating layers 15 provided on the punched surfaces 1d of the first arm portion 3 and the second arm portion 4 are disposed only on at least a portion (an entirety in the present preferred embodiment) of each contact portion 12 and at least a portion of each inclined surface portion 13 at the opposite direction X2 side of the sliding direction X1. The gold plating layer 15 provided on the inclined surface portion 13 at the opposite direction X2 side is provided to be continuous with the gold plating layer 15 provided on the contact portion 12.

As shown in FIG. 2, conductive portions 61 and 62 provided at respective surfaces of the connecting member 60 are connected to the contact portions 12 of the corresponding arm portions 3 and 4. Gold plating is applied to the conductive portions 61 and 62. The conductive portion 61 or 62 may be provided on a surface of just one side of the connecting member 60.

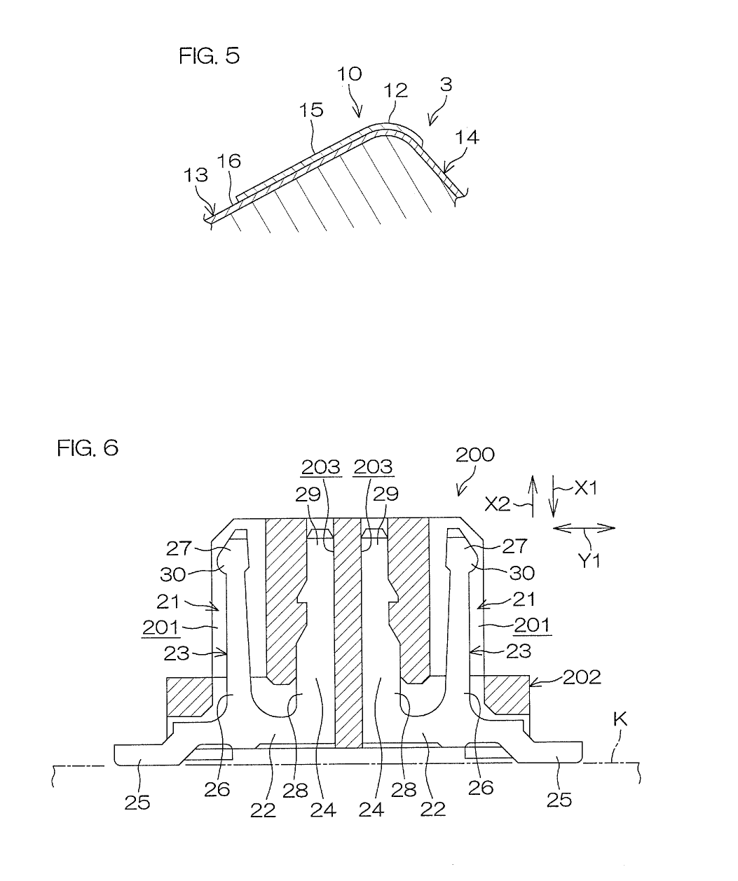

As shown in FIG. 5, a nickel plating layer 16 is provided on an entirety of a surface of the contact 1. The nickel plating layer 16 functions as a base plating layer at regions provided with the gold plating layer 15. At regions at which the gold plating layer 15 is not provided, the nickel plating layer 16 is exposed.

With the present preferred embodiment, an amount of gold can be reduced to reduce manufacturing cost because the gold plating layers 15 provided on the punched surfaces 1d of the respective arm portions 3 and 4 are disposed only on at least a portion of each inclined surface portion 13 at the opposite direction X2 side of the sliding direction X1 and at least a portion (the entire apex portion (contact portion 12) in the present preferred embodiment) of each apex portion (contact portion 12).

Also, the gold plating layers 15 are provided on the inclined surface portions 13 at the opposite direction X2 side of the sliding direction X1 and thus shaving off of a dissimilar metal (the nickel of the nickel plating layer 16 in the present preferred embodiment) can be suppressed until the conductive portions 61 and 62 at the respective surfaces of the connecting member 60 reach the contact portions 12 of the respective arm portions 3 and 4 of the contact 1. Consequently, interposition of nickel shavings or other dissimilar metal between the respective conductive portions 61 and 62 and the corresponding contact portions 12 after connection can be suppressed and increase in contact resistance can be suppressed.

Also, in regions in which the gold plating layer 15 is not provided, the nickel plating layer 16 that is capable of suppressing solder wetting is exposed and thus, for example, solder wicking at the lead portion 5 can be prevented effectively. Here, “solder wetting” refers to a phenomenon where melted solder spreads across a surface of a base material. Also, “solder wicking” refers to a phenomenon in which melted solder crawls up along a lead, etc.

Also, the first arm portion 3 and the second arm portion 4 are provided, and in regard to the sliding direction X1 (direction of extension of both arm portions 3 and 4), a position of the contact portion 12 of each of the arm portions 3 and 4 is overlapped with a position of a portion of the other arm portion 4 or 3. In manufacturing the contact 1 of the present preferred embodiment, it is possible to employ, for example, the masking method using the inkjet arrangement according to Patent Document 1 to mask the required portions before applying the gold plating and thereby apply the gold plating to the minimum necessary regions (only at least a portion of the contact portion 12 and at least a portion of the inclined surface portion 13 at the opposite direction X2 side on the punched surface 1d of each of the arm portions 3 and 4).

Although masking tends to be difficult to apply in the case where the contact portions 12 of both arm portions 3 and 4 project mutually toward the facing arm portion 4 and 3 sides (project inward) as in the present preferred embodiment or, although not illustrated, in a case where the apex portion making up the contact portion of either one of the arm portions projects toward the other arm portion side, masking can be applied with good positional precision, for example, by employing the masking method using the inkjet arrangement according to Patent Document 1.

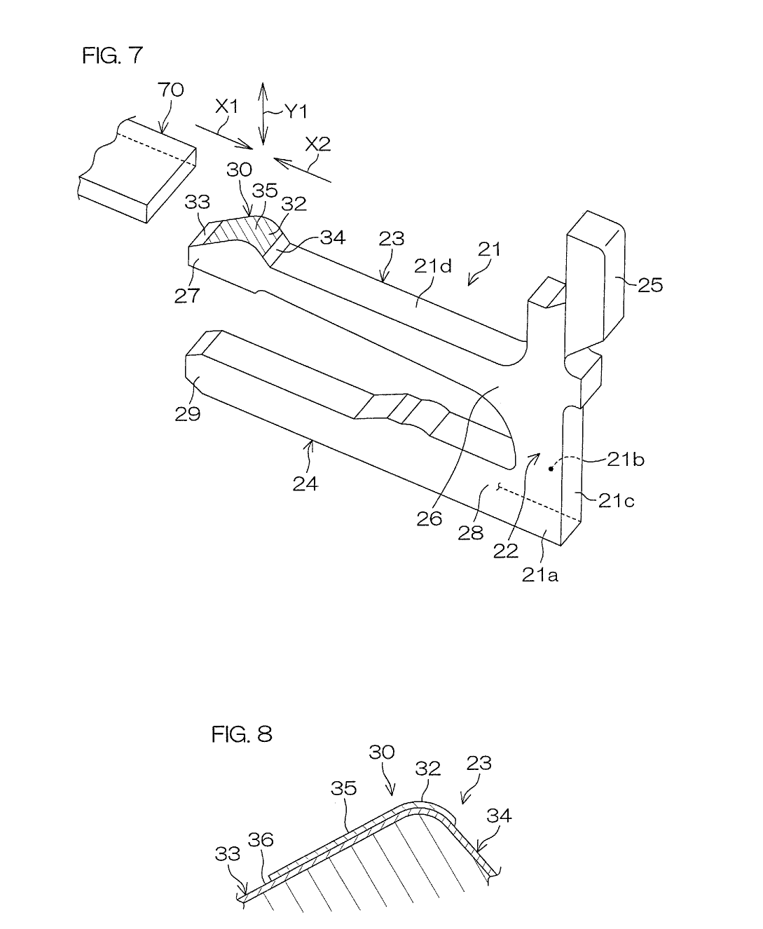

Next, FIG. 6 is a schematic sectional view of an electrical connector that includes contacts according to another preferred embodiment of the present invention, and FIG. 7 is a schematic perspective view of a contact of FIG. 6. The electrical connector 200 includes a housing 202, made of an insulating synthetic resin and having one pair of housing grooves 201 that open to respective sides, and the contacts 21 held by the housing 202. Each contact 21 is fixed to a substrate K by soldering, etc.

Referring to FIG. 7, each contact 21 is a so-called punched contact formed through a process of punching a plate material by a press. The contact 21 is a fork-shaped contact that is connected to a connecting member 70, which is made up of a plate-like contact inserted along a predetermined sliding direction X1. An entirety of the connecting member 70 is arranged as a conductive portion. Gold plating may be applied to a portion of a surface of the connecting member 70 that is the portion connected to the contact 21.

The contact 21 has one pair of plate surfaces 21a and 21b and a punched surface 21c intersecting the pair of plate surfaces 21a and 21b and connecting the two plate surfaces 21a and 21b across an entire circumference. As shown in FIG. 6 and FIG. 7, the contact 21 has a main body portion 22 with a substantially rectangular shape, a first arm portion 23 and a second arm portion 24 extending substantially in parallel in an opposite direction X2 of the sliding direction X1 from one end of the main body portion 22, and a lead portion 25 extending in a direction orthogonal to the sliding direction X1 from another end of the main body portion 22.

The first arm portion 23 includes a base end portion 26 coupled to the main body portion 22 and a tip end portion 27 that is a free end and functions as an elastic arm portion. The first arm portion 23 is housed in the housing groove 201 of the housing 202. The second arm portion 44 includes a base end portion 28 coupled to the main body portion 22 and a tip end portion 29, and as shown in FIG. 6, functions as a fixed arm portion that is fixed by being press fitted into a fixing hole 203 of the housing 202.

Referring to FIG. 6 and FIG. 7, the first arm portion 23, which is the elastic arm portion, has, at its tip end portion 27, a first chevron portion 30 projecting outwardly (to an opposite side with respect to the second arm portion 24) in a direction Y1 intersecting the sliding direction X1. By sliding in parallel to the first arm portion 23, the connecting member 70 is connected to the first arm portion 23.

As shown in FIG. 7, the first chevron portion 30 of the first arm portion 23 is formed on a portion of the punched surface 21c that is a punched surface 21d of the first arm portion 23. The first chevron portion 30 includes an apex portion that makes up a contact portion 32 and one pair of inclined surface portions 33 and 34 disposed at respective sides of the apex portion (contact portion 32). The inclined surface portion 33 is disposed at the opposite direction X2 side with respect to the contact portion 32 and the inclined surface portion 34 is disposed at the sliding direction X1 side with respect to the contact portion 32.

A gold plating layer 35 (corresponding to a hatched portion in FIG. 7) is coated on the punched surface 21d of the first arm portion 23. The gold plating layer 35 provided on the punched surface 21d of the first arm portion 23 is disposed only on at least a portion (an entirety in the present preferred embodiment) of the contact portion 32 and at least a portion of the inclined surface portion 33 at the opposite direction X2 side of the sliding direction X1. The gold plating layer 35 provided on the inclined surface portion 33 at the opposite direction X2 side is provided to be continuous with the gold plating layer 35 provided on the contact portion 32.

As shown in FIG. 8, a nickel plating layer 36 is provided as a dissimilar metal plating layer on an entirety of the contact 21, and the nickel plating layer 36 functions as a base plating layer at regions provided with the gold plating layer 35. At regions at which the gold plating layer 35 is not provided, the nickel plating layer 36 is exposed.

With the present preferred embodiment, the amount of gold can be reduced to reduce the manufacturing cost because the gold plating layer 35 provided on the punched surface 21d of the first arm portion 23 is disposed only on at least a portion of the inclined surface portion 33 at the opposite direction X2 side of the sliding direction X1 and at least a portion of the apex portion (contact portion 32).

Also, the gold plating layer 35 is provided on the inclined surface portion 33 at the opposite direction X2 side of the sliding direction X1 and thus shaving off of a dissimilar metal (the nickel of the nickel plating layer 36 in the present preferred embodiment) can be suppressed until the connecting member 70 reaches the contact portion 32 of the first arm portion 23 of the contact 21. Consequently, interposition of nickel shavings or other dissimilar metal between the connecting member 70 and the corresponding contact portion 32 after connection can be suppressed and increase in contact resistance can be suppressed.

Also, in regions in which the gold plating layer 35 is not provided, the nickel plating layer 36 that is capable of suppressing solder wetting is exposed and thus, for example, solder wicking at the lead portion 25 can be prevented effectively.

Also, the first arm portion 23 and the second arm portion 24 are provided and in regard to the sliding direction X1 (direction of extension of both arm portions 23 and 24), a position of the contact portion 32 of the first arm portion 23 is overlapped with a position of a portion of the second arm portion 24. In manufacturing the contact 21 of the present preferred embodiment, it is possible to employ, for example, the masking method using the inkjet arrangement according to Patent Document 1 to mask the required portions before applying the gold plating and thereby apply the gold plating to the minimum necessary regions [only at least a portion (the entirety in the present preferred embodiment) of the contact portion 32 and at least a portion of the inclined surface portion 33 at the opposite direction X2 side of the punched surface 21d of the first arm portion 23].

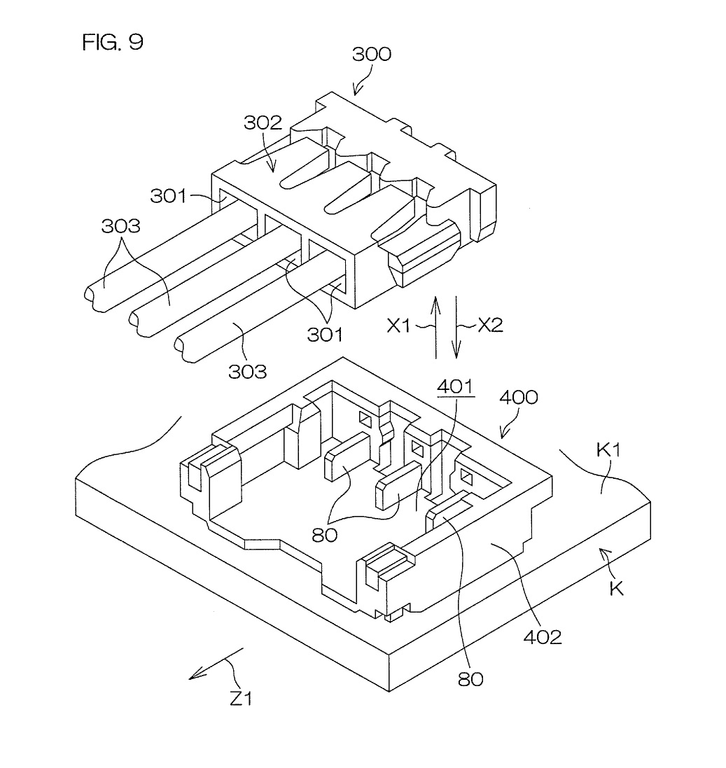

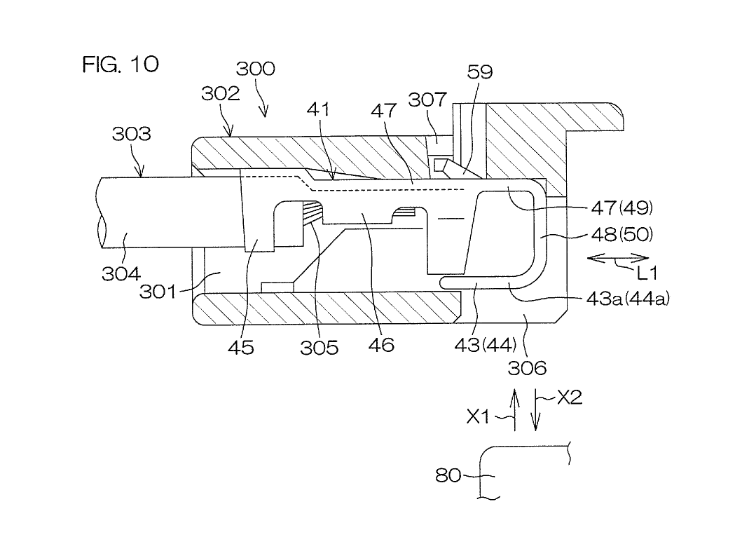

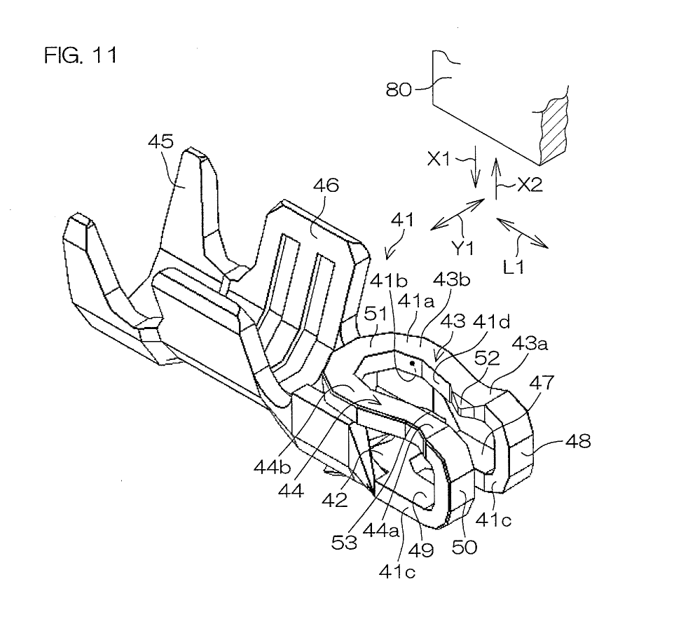

Next, FIG. 9 is a schematic exploded perspective view of a socket connector 300 as an electrical connector that includes contacts according to yet another preferred embodiment of the present invention and a counterpart base connector 400 mounted to a mounting surface K1 of a substrate K. FIG. 10 is a schematic sectional view of the socket connector 300, and FIG. 11 is a schematic perspective view before crimping of a contact 41 of the socket connector 300.

As shown in FIG. 9, the socket connector 300 is insertable in an insertion recess 401 of the base connector 400. The socket connector 300 is used, for example, for connecting a battery and a circuit board of a cell phone.

The insertion recess 401 of the base connector 400 is opened in a direction away from the mounting surface K1 of the substrate K that is a direction orthogonal to the mounting surface K1 (direction corresponding to an extraction direction of the socket connector 300) and is opened at a front side Z1 among directions parallel to the mounting surface K1. The base connector 400 includes a housing 402 made of an insulating synthetic resin and forming the insertion recess 401 and connecting members 80 each made up of a plate-like contact that is partially exposed to the insertion recess 401 and held by the housing 402. The entirety of each connecting member 80 is arranged as a conductive portion.

The socket connector 300 includes a housing 302 having a plurality of housing holes 301 aligned in a horizontal row. As shown in FIG. 10, a contact 41 crimped to a terminal portion of an electric wire 303 is housed and held in each housing hole 301.

Referring to FIG. 10 and FIG. 11, with respect to the contacts 41 of the socket connector 300, the plate-like connecting members 80 (corresponding to counterpart contacts) of the counterpart base connector 400 become connected upon sliding along a predetermined sliding direction X1.

Each contact 41 includes a main body portion 42 provided with barrels for crimping onto the end portion of the electrical wire 303 and a first arm portion 43 and a second arm portion 44 that extend in parallel to each other. The main body portion 42 is provided with an insulation barrel 45 for crimping onto an insulation covered portion 304 of the electrical wire 303 and a wire barrel 46 for crimping onto a core wire 305 of the electrical wire 303.

A supporting arm portion 47 extending in a longitudinal direction L1 of the contact 41 from the main body portion 42 is provided and a coupling arm portion 48 that is bent from the supporting arm portion 47 is coupled to a base end portion 43a of the first arm portion 43. The first arm portion 43 is thus supported by the main body portion 42 via the supporting arm portion 47 and the coupling arm portion 48.

In the same manner, a supporting arm portion 49 extending in the longitudinal direction L1 of the contact 41 from the main body portion 42 is provided and a coupling arm portion 50 that is bent from the supporting arm portion 49 is coupled to a base end portion 44a of the second arm portion 44. The second arm portion 44 is thus supported by the main body portion 42 via the supporting arm portion 49 and the coupling arm portion 50. As shown in FIG. 10, an insertion recess 306 into which the connecting member 80 is inserted is formed in the housing 302 of the socket connector 300 and the first arm portion 43 and the second arm portion 44 penetrate inside the insertion recess 306. A lance 59, made up of an elastic projection extending from the main body portion 42 of the contact 41, latches in an engaging hole 307 of the housing 302 and extraction of the contact 41 from the housing hole 301 is thereby prevented.

Also, as shown in FIG. 11, a tip end portion 43b of the first arm portion 43 and a tip end portion 44b of the second arm portion 44 are coupled integrally via a curved coupling arm portion 51. The pair of supporting arm portions 47 and 49, the pair of coupling arm portions 48 and 50, the first arm portion 43, the second arm portion 44, and the coupling arm portion 51 are formed integral to and of the same material as the main body portion 42 and include one pair of plate surfaces 41a and 41b and a punched surface 41c. Specifically, these portions are formed by forming a plate material to a U-like shape by punching and thereafter bending intermediate portions.

A first chevron portion 52 and a second chevron portion 53 that project mutually inward in the direction Y1 that intersects the sliding direction X1 are provided, at the respective base end portions 43a and 44a of the first arm portion 43 and the second arm portion 44.

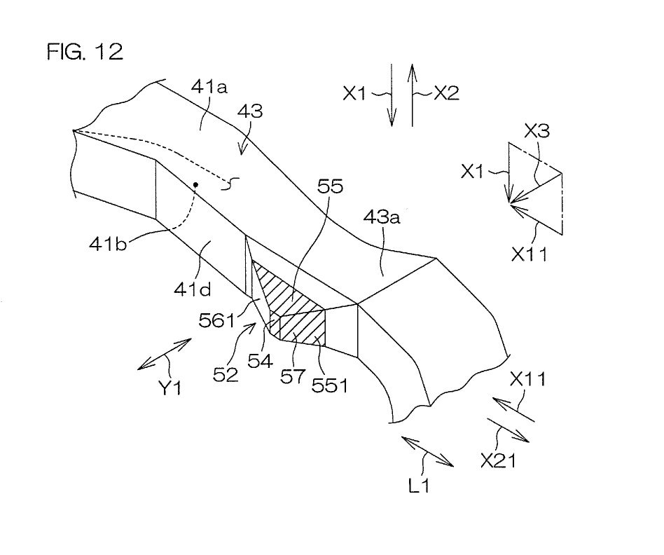

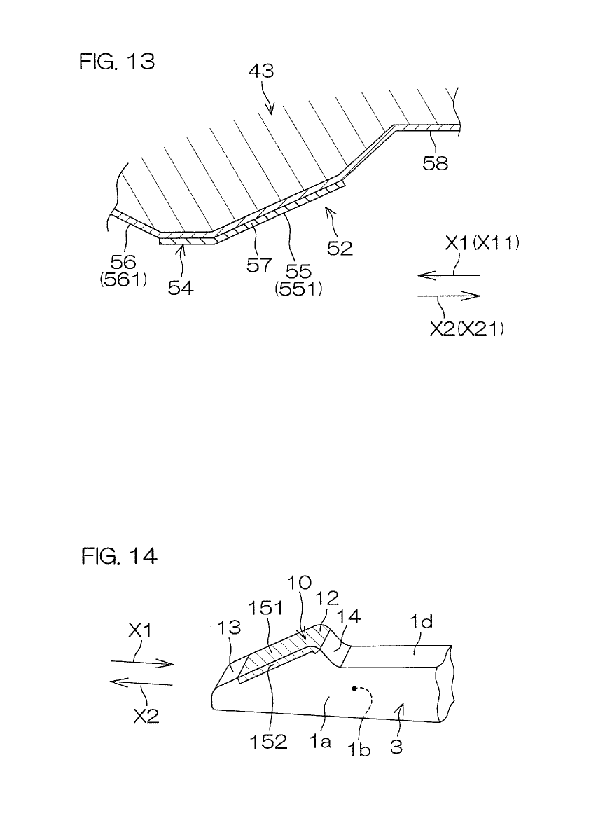

The first chevron portion 52 of the first arm portion 43 and the second chevron portion 53 of the second arm portion 44 make up a symmetrical structure and a description shall thus be provided based on the first chevron portion 52 of the first arm portion 43. As shown in FIG. 12, the first chevron portion 52 of the first arm portion 43 is formed on a portion of the punched surface 41c that is a punched surface 41d of the first arm portion 43. The first chevron portion 52 includes an apex portion making up a contact portion 54 and an inclined surface portion 55 at one side and an inclined surface portion 56 at another side (not illustrated in FIG. 12; see FIG. 13) disposed at respective sides of the apex portion (contact portion 54) in regard to the sliding direction X1. The inclined surface portion 55 at one side is disposed at the opposite direction X2 side of the sliding direction X1 with respect to the contact portion 54 and the inclined surface portion 56 at the other side is disposed at the sliding direction X1 side with respect to the contact portion 54.

In order to accommodate not only a case where the counterpart connecting member 80 is inserted along the sliding direction X1 as shown in FIG. 12 but also to accommodate a case where, with the sliding direction X1 being a first sliding direction, the connecting member 80 is inserted along a second sliding direction X11 (corresponding to the longitudinal direction L1) orthogonal to the first sliding direction X1 or inserted along a third sliding direction X3 obliquely intersecting the first sliding direction X1 and the second sliding direction X2, the contact 41 of the present preferred embodiment is provided with one pair of inclined surface portions 551 and 561 disposed at respective sides of the contact portion 54 in regard to the second sliding direction X11.

A gold plating layer 57 (a hatched portion in FIG. 12) is coated only on a portion of the punched surface 41d of the first arm portion 43. The gold plating layer 57 provided on the punched surface 41d of the first arm portion 43 is disposed only on at least a portion (the entirety in the present preferred embodiment) of the contact portion 54 as the apex portion and at least portions of the inclined surface portions 55 and 551 at the opposite direction X2 and X21 sides of the respective sliding directions X1 and X11. The gold plating layer 57 provided on the inclined surface portions 55 and 551 at the opposite direction X2 and X21 sides is provided to be continuous with the gold plating layer 57 provided on the contact portion 54.

As shown in FIG. 13, a nickel plating layer 58 is provided on an entirety of the contact 41, and the nickel plating layer 58 functions as a base plating layer at regions provided with the gold plating layer 57. At regions at which the gold plating layers 57 are not provided, the nickel plating layer 58 is exposed.

With the present preferred embodiment, the amount of gold can be reduced to reduce the manufacturing cost because the gold plating layer 57 provided on the punched surface 41d of the first arm portion 43 is disposed only on at least portions of the inclined surface portions 55 and 551 at the opposite direction X2 and X21 sides of the sliding directions X1 and X11 and at least a portion (the entirety in the present preferred embodiment) of the apex portion (contact portion 54).

Also, the gold plating layer 57 is provided on the inclined surface portions 55 and 551 at the opposite direction X2 and X21 sides of the sliding directions X1 and X11 and thus shaving off of a dissimilar metal (the nickel of the nickel plating layer 58 in the present preferred embodiment) can be suppressed until the connecting member 80 reaches the contact portions 54 of the respective arm portions 43 and 44 of the contact 41. Consequently, interposition of nickel shavings or other dissimilar metal between the connecting member 80 and the corresponding contact portions 54 after connection can be suppressed and increase in contact resistance can be suppressed.

Also, in regions in which the gold plating layer 57 is not provided, the nickel plating layer 58 is exposed and the corrosion resistance can thus be improved.

Also, the first arm portion 43 and the second arm portion 44 are provided and in regard to the direction of extension of both arm portions 43 and 44, a position of the contact portion 54 of each of the arm portions 43 and 44 is overlapped with a position of a portion of the other arm portion 44 or 43, and by employing, for example, the masking method using the inkjet arrangement according to Patent Document 1 to mask the required portions before applying the gold plating, the gold plating can be applied to the minimum necessary regions [only at least a portion (the entirety in the present preferred embodiment) of the contact portion 54 and at least portions of the inclined surface portions 55 and 551 at the opposite direction X2 and X21 sides of the sliding directions X1 and X11 of the punched surface 41d of each of the arm portions 43 and 44].

The present invention is not restricted to the preferred embodiments described above, and for example, as a modification example of the preferred embodiment of FIG. 1, it is preferable for a second gold plating layer 152, continuous with a first gold plating layer 151 as the gold plating layer of the punched surface 1d, to be provided at least on one of either of the pair of plate surfaces 1a and 1b (on the plate surface 1a in the example of FIG. 14) as intersecting surfaces of the first arm portion 3 that intersect the punched surface 1d of the first arm portion 3 as shown in FIG. 14.

The following merit is provided in this case. That is, by visually or otherwise checking the presence of the second gold plating layer 152 on the plate surface 1a or 1b as the intersecting surface, the presence or non-presence of the first gold plating layer 151 of the punched surface 1d that is hard to recognize visually can be recognized. A simple inspection is thus enabled. The second plating layer 152 suffices to be of a small amount as long as its presence can be recognized visually and thus increase in manufacturing cost can be suppressed.

Also, although not illustrated, a second gold plating layer may be provided on at least one of either of the pair of plate surfaces 21a and 21b as intersecting surfaces in the preferred embodiment of FIG. 7, and a second gold plating layer may be provided on at least one of either of the pair of plate surfaces 41a and 41b as intersecting surfaces in the preferred embodiment of FIG. 11.

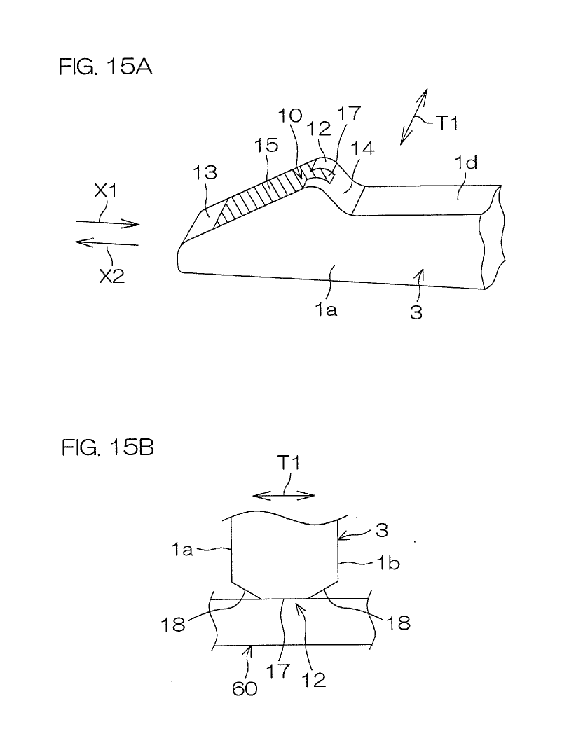

Also, as a modification example of the preferred embodiment of FIG. 1, the gold plating layer 15 coated on the apex portion making up the contact portion 12 may, as shown in FIG. 15A, be formed on a portion of the contact portion 12 (for example, at a central portion 17 in a plate thickness direction Z1 that is a punching direction). Usually, as shown in FIG. 15B, chamfered portions 18 are formed at both side edges in the plate thickness direction at the contact portion 12 of the contact 1, and the chamfered portions 18 do not contact the counterpart connecting member 60. Thus, by applying the gold plating restrictingly only at the central portion 17 (portion that actually contacts the counterpart connecting member 60) and excluding the chamfered portions 18 in the contact portion 12, further cost reduction can be achieved.

Also, although not illustrated, the gold plating layer 35 may be provided on a portion (for example, at a central portion in a plate thickness direction that is a punching direction) of the contact portion 32 in the preferred embodiment of FIG. 7, and the gold plating layer 57 may be provided on a portion of the contact portion 54 in the preferred embodiment of FIG. 11.

The present invention has been described in detail above by way of specific embodiments, and a person skilled in the art who has understood the above contents can readily conceive of changes, modifications, and equivalents thereof. The present invention shall thus be deemed to cover the scope of the claims and the scope of the equivalents of the claims.

The present application corresponds to Japanese Patent Application No. 2011-220021 filed on Oct. 4, 2011 in the Japan Patent Office, the entire disclosure of which is incorporated herein by reference.

1. A contact having a contact portion to which a conductive portion of a connecting member is connected upon sliding in at least one sliding direction, the contact comprising:
an arm portion; and
wherein the arm portion includes a punched surface, a chevron portion provided on the punched surface and projecting in a direction intersecting the sliding direction, and a gold plating layer provided on the punched surface,
the chevron portion has an apex portion making up the contact portion and at least one pair of inclined surface portions disposed at respective sides of the apex portion in regard to the sliding direction, and
the gold plating layer provided on the punched surface is disposed only on at least a portion of the inclined surface portion at an opposite direction side of the sliding direction and at least a portion of the apex portion.

2. The contact according to claim 1, wherein
a dissimilar metal plating layer of a metal dissimilar to gold is provided on an entire surface of the arm portion, and
the gold plating layer is provided on a surface of the dissimilar metal plating layer.

3. The contact according to claim 1, further comprising
a first arm portion as the arm portion, and
a second arm portion extending in parallel to the first arm portion,
wherein in regard to a direction of extension of both arm portions, a position of a contact portion of the first arm portion overlaps with a position of a portion of the second arm portion.

4. The contact according to claim 3, wherein
the first arm portion includes a first chevron portion as the chevron portion including a first contact portion as the contact portion, and
the first chevron portion projects toward the second arm portion.

5. The contact according to claim 3, wherein
the first arm portion includes a first chevron portion as the chevron portion including a first contact portion as the contact portion, and
the first chevron portion projects toward an opposite side with respect to the second arm portion.

6. The contact according to claim 1, wherein
the arm portion includes a plate surface that intersects the punched surface, and
a second gold plating layer, continuous with a first gold plating layer as the gold plating layer on the punched surface, is provided on the plate surface.

7. The contact according to claim 1, wherein
the sliding direction includes a first sliding direction and a second sliding direction intersecting the first sliding direction,
the at least one pair of inclined surface portions of the chevron portion includes one pair of inclined surface portions disposed at respective sides of the apex portion in regard to the first sliding direction and one pair of inclined surface portions disposed at respective sides of the apex portion in regard to the second sliding direction, and
the gold plating layer provided on the punched surface is disposed only on at least a portion of the inclined surface portion at an opposite direction side of the first sliding direction, at least a portion of the inclined surface portion at an opposite direction side of the second sliding direction, and at least a portion of the apex portion.

8. The contact according to claim 1, wherein
the gold plating layer disposed on the apex portion is disposed at a central portion in a plate thickness direction as a punching direction of the punched surface.

9. An electrical connector comprising:
a contact having a contact portion to which a conductive portion of a connecting member is connected upon sliding in at least one sliding direction; and
an insulating housing holding the contact; and
wherein the contact includes an arm portion,
the arm portion includes a punched surface, a chevron portion provided on the punched surface and projecting in a direction intersecting the sliding direction, and a gold plating layer provided on the punched surface,
the chevron portion has an apex portion making up the contact portion and at least one pair of inclined surface portions disposed at respective sides of the apex portion in regard to the sliding direction, and
the gold plating layer provided on the punched surface is disposed only on at least a portion of the inclined surface portion at an opposite direction side of the sliding direction and at least a portion of the apex portion.
